(19) United States
(12) Patent Application Publication
(10) Pub. No.: US 2011/0317004 A1
(43) Pub. Date: Dec. 29, 2011

(54) IV Monitoring by Digital Image Processing

(76) Inventor: Kai Tao, Yizheng (CN)

(21) Appl. No.: 12/825,368

(22) Filed: Jun. 29, 2010

(51) Int. Cl. H04N 7/18; G06K 7/14; B42D 15/00; G06K 19/06

(52) U.S. Cl. 348/135; 235/494; 235/462.01; 283/81; 348/E07.085

(57) ABSTRACT

We describe an apparatus using an image capturing device to obtain image of the IV container, and uses digital image processing technique to analyze information in the image. We also describe the use of barcode which can read by the apparatus so that relevant information of the drug, container, and the patient can be made use of.

### CROSS-REFERENCE TO RELATED APPLICATIONS

U.S. Pat. No. 4,383,252 Intravenous Drip Feed Monitor

U.S. Pat. No. 6,736,801 Method and Apparatus for Monitoring Intravenous Drips

### FEDERALLY SPONSORED RESEARCH

Not Applicable

### THE NAMES OF THE PARTIES TO A JOINT RESEARCH AGREEMENT

Not Applicable

### SEQUENCE LISTING OR PROGRAM

Not Applicable

### BACKGROUND

1. Field of Intention

This invention relates to
1. IV dripping monitoring
2. Use of barcode in IV monitoring

2. Prior Art

IV dripping usually takes a long time. Attempts have been made to automatically monitor the process and there are some existing systems. Most of them use physical approaches.

One category of methods is to count the drops, and these are typically done by using optical sensors. There are several US patents falls in this category, for example:
1. U.S. Pat. No. 4,383,252 Intravenous Drip Feed Monitor, which uses combination of a diode and phototransistor to detect drips.
2. U.S. Pat. No. 6,736,801 Method and Apparatus for Monitoring Intravenous Drips, which uses infrared or other types of emitter and a sensor combined to count the drips.

Apparatus that counts number of drops can serve chiefly two purposes:
1. Alarm when the dripping speed deviates too much from a predetermined value
2. Alarm when dripping has stopped to prevent infiltration

Our invention addresses these problems from a different perspective. We use camera to capture image of the IV container and use digital image processing technique to monitor this process.

### SUMMARY

We describe methods for IV dripping monitoring using digital image processing technique. We also describe the use of barcode to provide relevant information to the monitoring program.

### DRAWINGS

### Figures

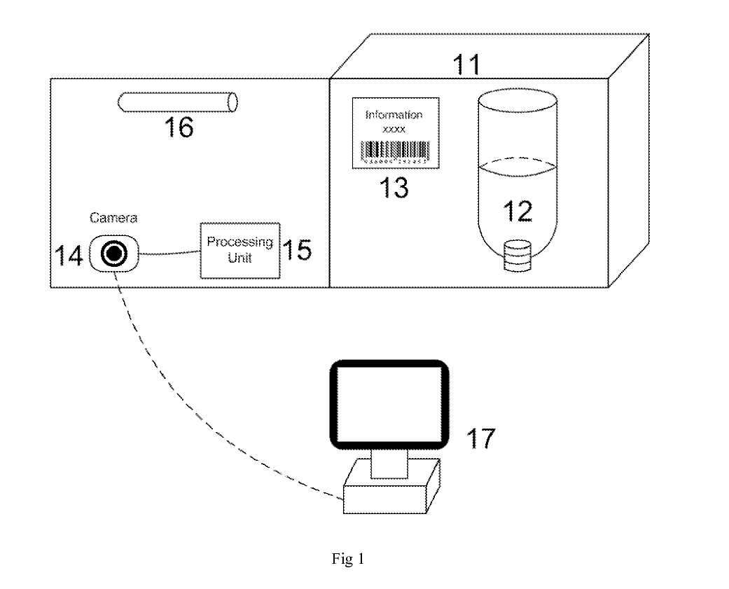

FIG. 1 shows one possible embodiment of the hardware

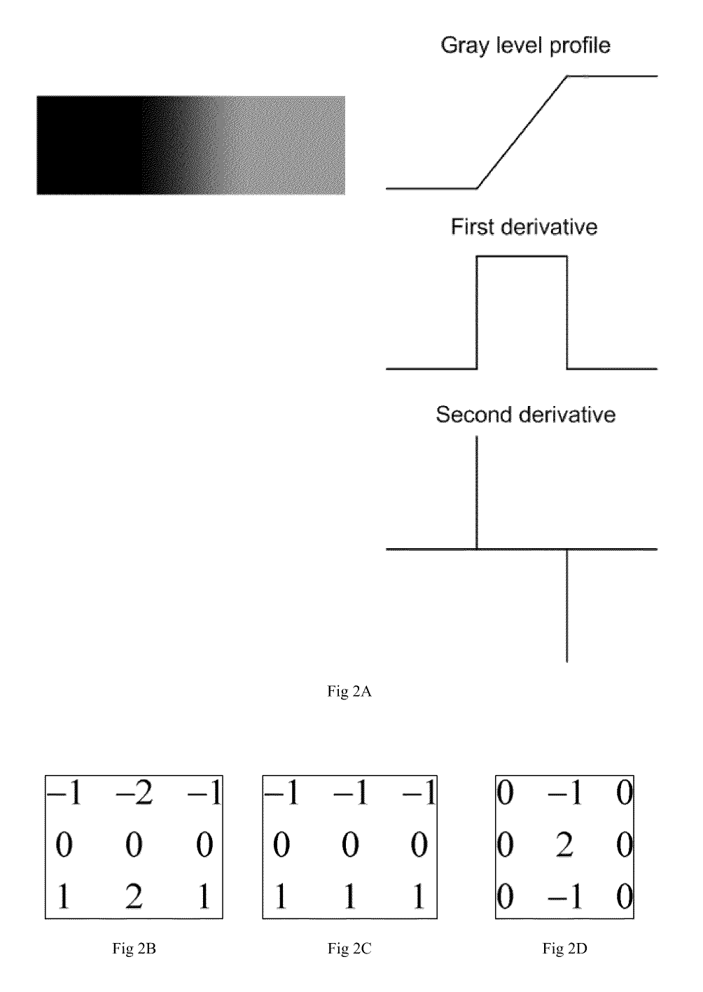

FIG. 2A to 2D introduces basic concepts and tools for digital image processing.
1. FIG. 2A illustrates the concept of derivatives in digital image processing.
2. FIG. 2B shows the vertical Sobel gradient operator.
3. FIG. 2C shows the vertical Prewitt gradient operator.
4. FIG. 2D shows the vertical Laplacian operator.

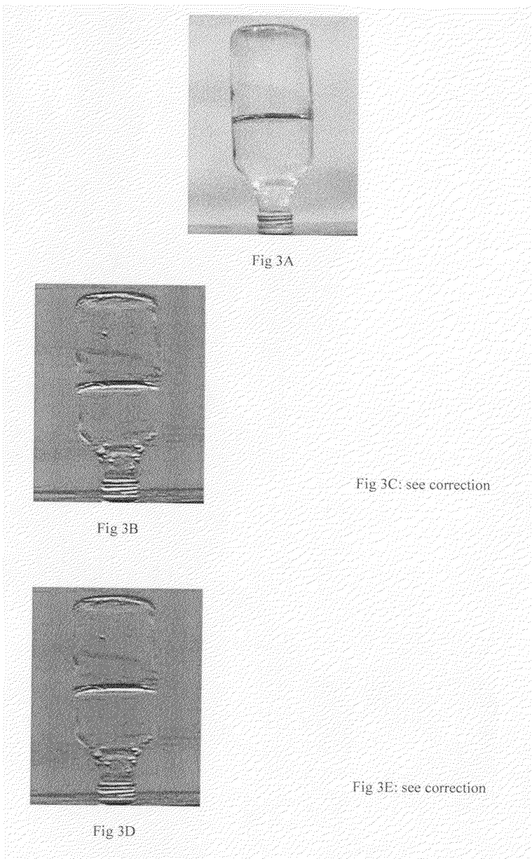

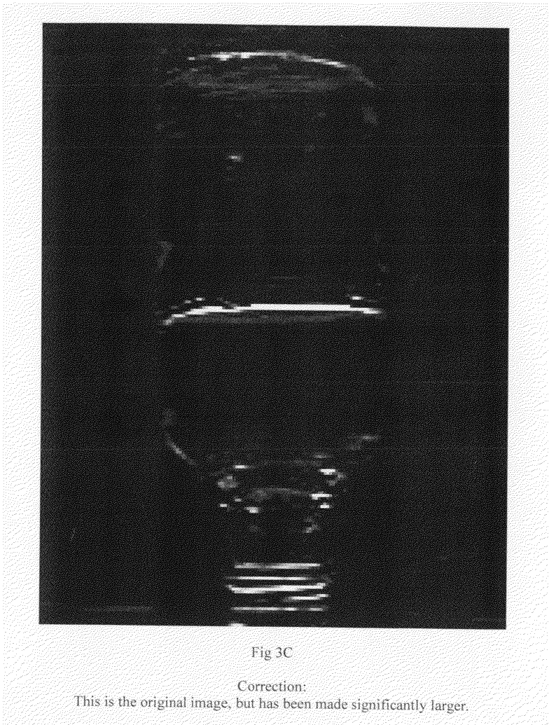

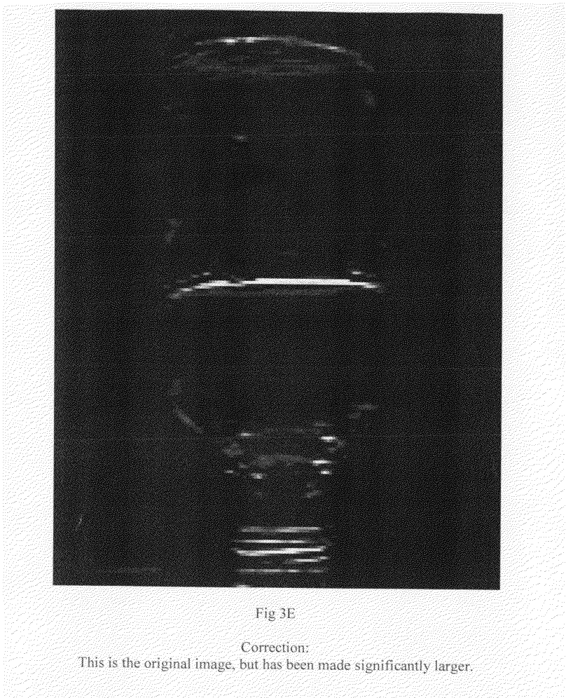

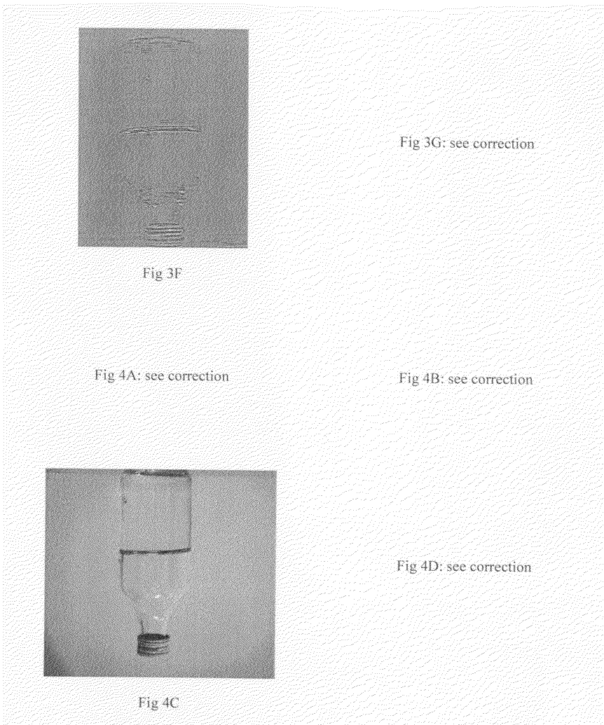

FIG. 3A to 3G shows the effect of applying operators in FIG. 2B-2D to the image of a glass bottle with liquid inside.
1. FIG. 3A is the captured image of the bottle.
2. FIG. 3B is the result after applying FIG. 2B (Sobel) and properly scaled.
3. FIG. 3C is the result after applying FIG. 2B and takes only nonnegative values.
4. FIG. 3D is the result after applying FIG. 2C (Prewitt) and properly scaled.
5. FIG. 3E is the result after applying FIG. 2C and takes only nonnegative values.
6. FIG. 3F is the result after applying FIG. 2D (Laplacian) and properly scaled.
7. FIG. 3G is the result after applying FIG. 2D and takes only nonnegative values.

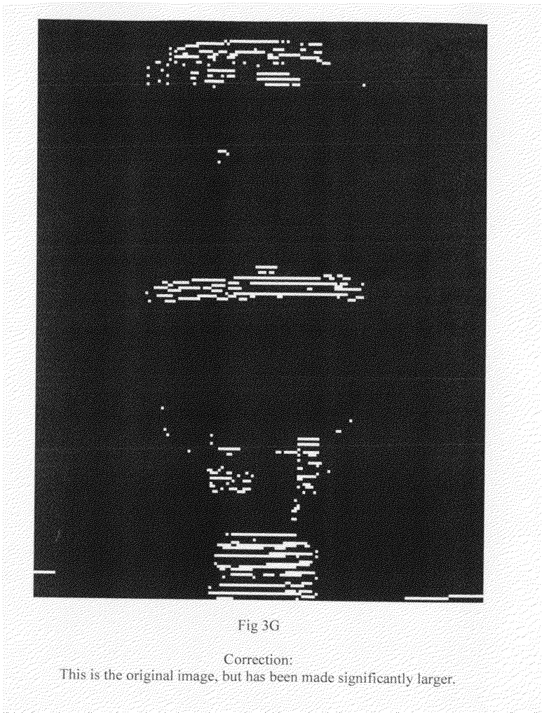

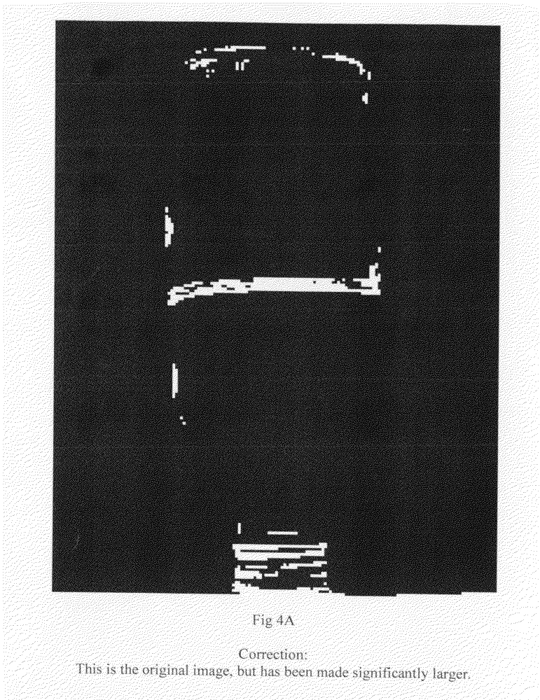

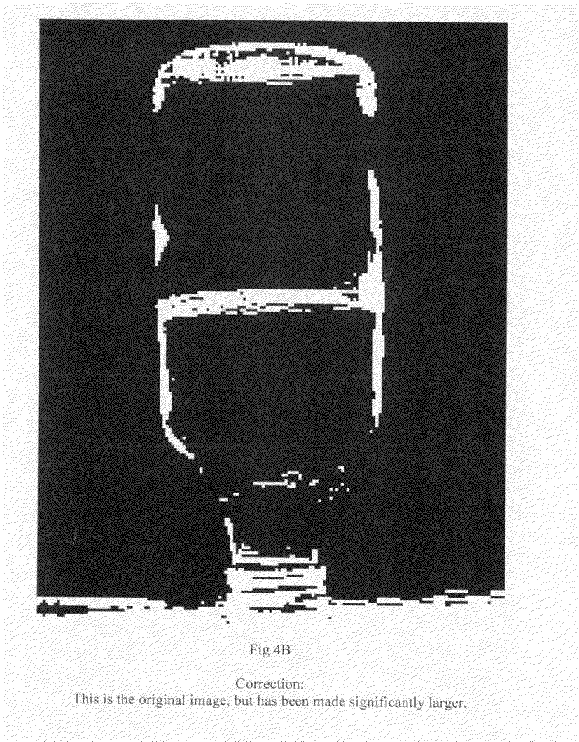

FIG. 4A to 4D shows the result of directly applying thresholding to captured images.
1. FIG. 4A is the result of applying thresholding to FIG. 3A. The threshold level was manually selected.
2. FIG. 4B is the result of thresholding FIG. 3A using Otsu's method.
3. FIG. 4C is an image captured on the same bottle as in FIG. 3A but before a different background.
4. FIG. 4D is the result of applying thresholding to FIG. 4B using the same threshold as in FIG. 4A.

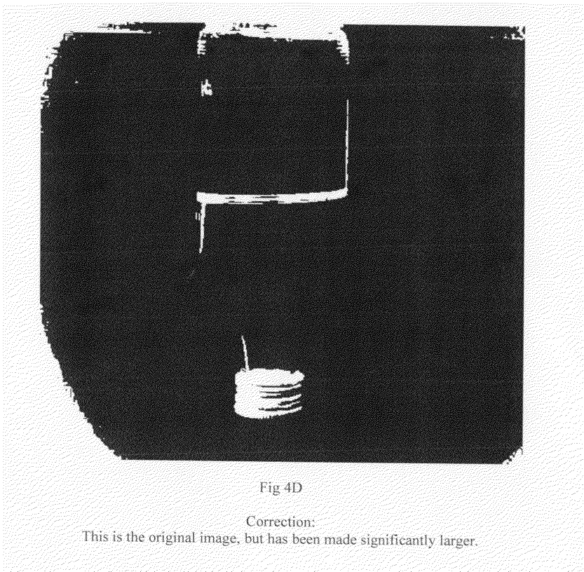

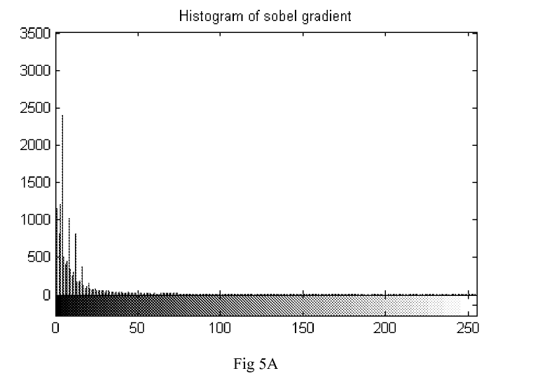

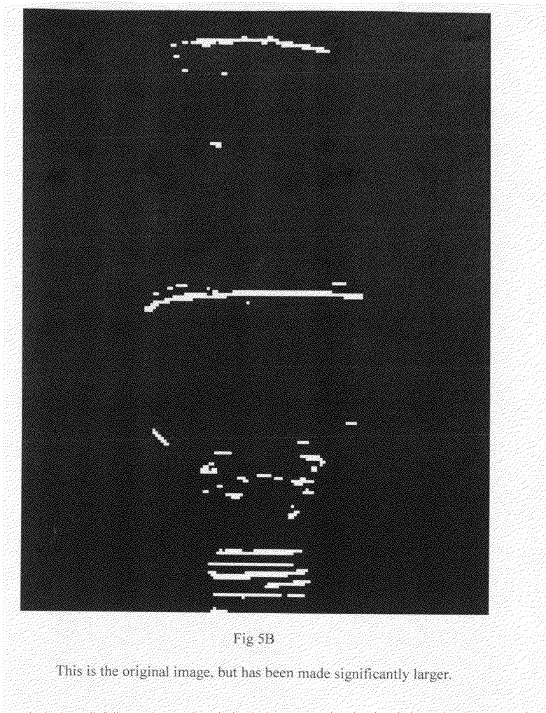

FIG. 5A to 5F shows the method for finding the location of the liquid surface and the cap of the bottle.
1. FIG. 5A shows the image histogram for FIG. 3C.
2. FIG. 5B is the thresholding result of FIG. 5A using Otsu's method.
3. FIG. 5C is the vertical profile of FIG. 5B.
4. FIG. 5D shows the local peaks of FIG. 5C.
5. FIG. 5E shows the locations of liquid surface and bottle cap found with FIG. 5D.
6. FIG. 5F shows the task of FIG. 5E being performed using Hough transform.

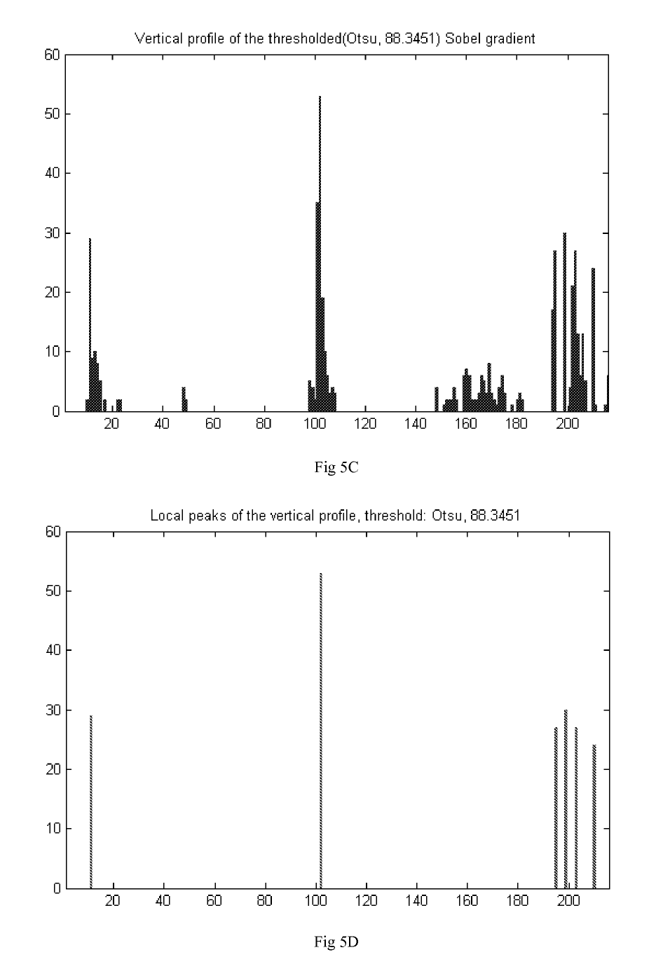

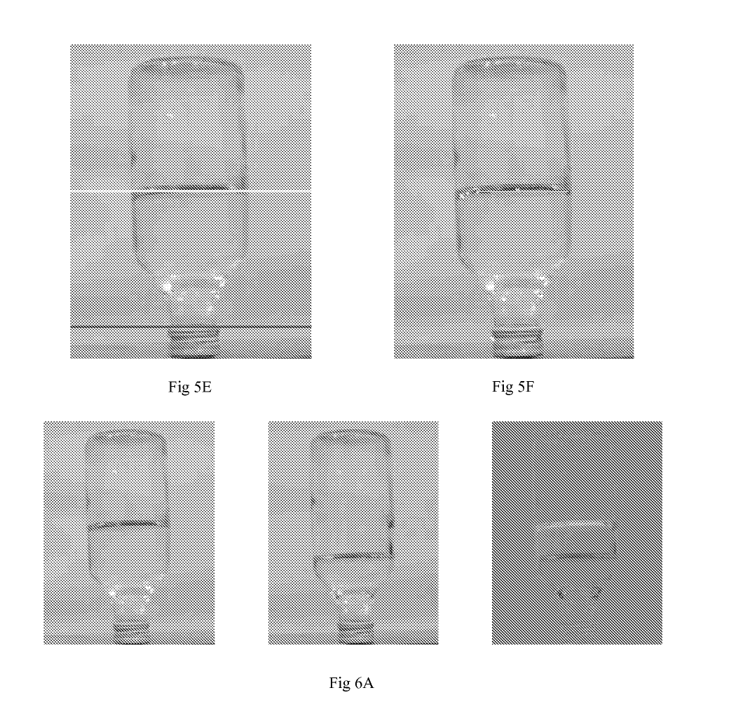

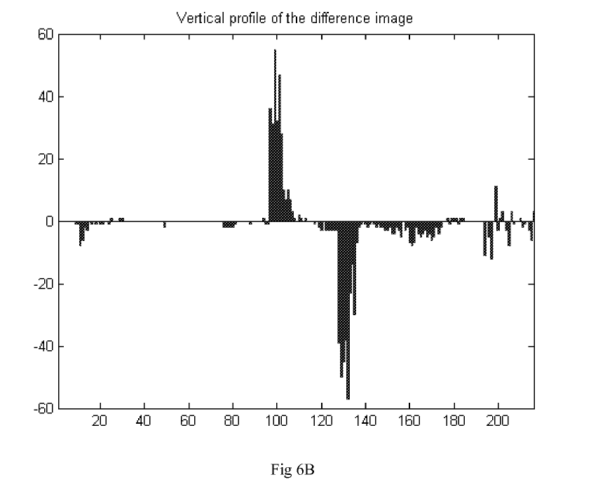

FIG. 6A shows the result of subtracting two images taken at different times.

FIG. 6B shows the vertical profile of the difference images.

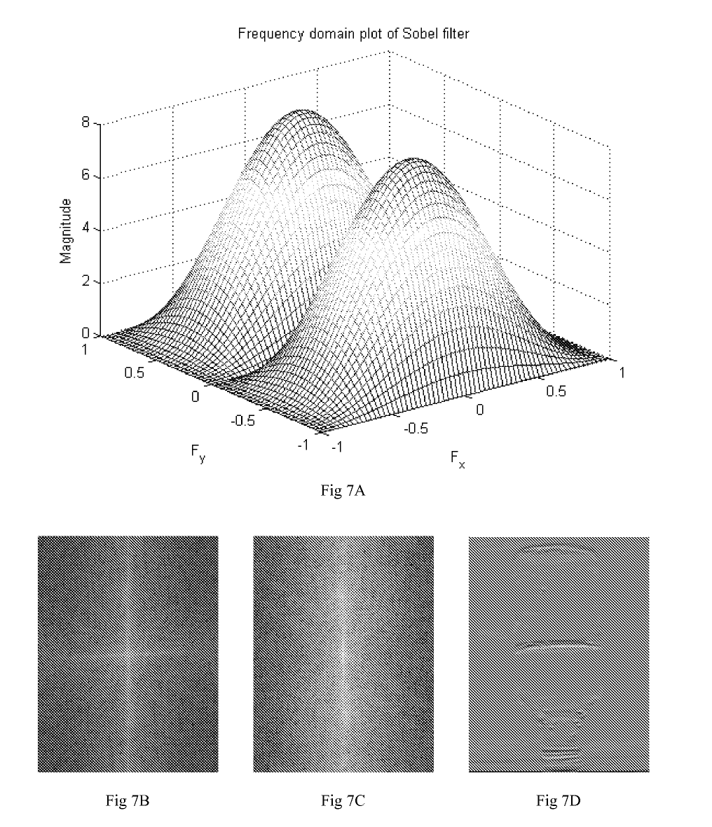

FIG. 7A shows the frequency domain plot of the Sobel gradient in FIG. 2B.

FIG. 7B shows the frequency domain plot of FIG. 3A.

FIG. 7C shows the frequency domain plot after FIG. 7B has been filtered by FIG. 7A.

FIG. 7D shows the inverse Fourier transform of FIG. 7C.

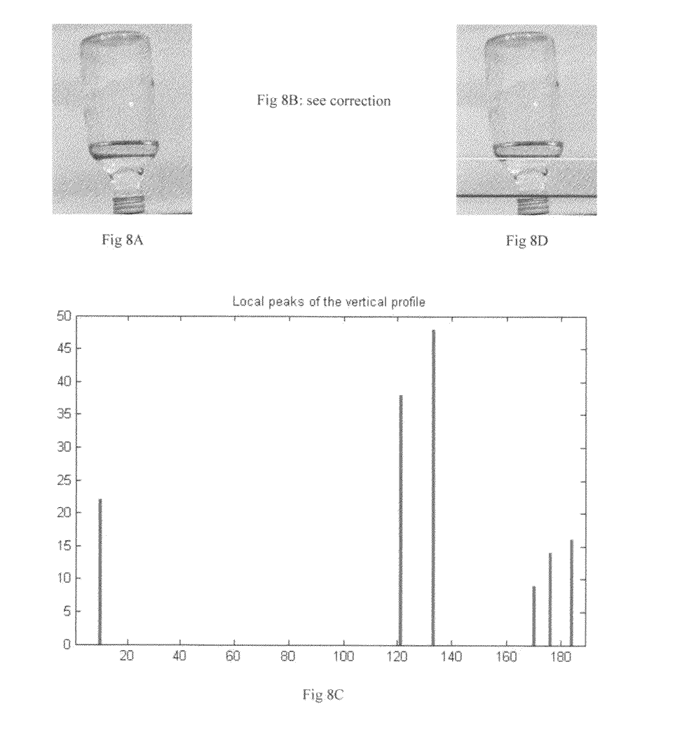

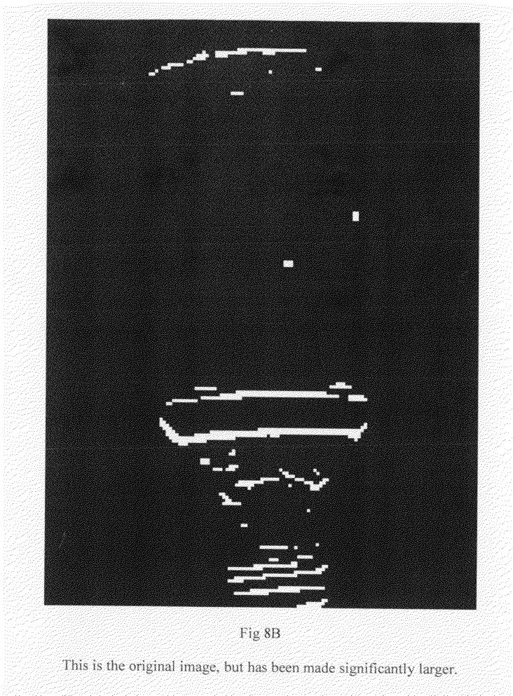

FIG. 8A to 8D shows the case when double peaks of the liquid surface are found.
1. FIG. 8A is an image which has two prominent edges of the liquid surface.
2. FIG. 8B is the result of FIG. 8A after applying Sobel gradient operator and being thresholded.
3. FIG. 8C shows local peaks of the vertical profile of FIG. 8B.
4. FIG. 8D shows the locations of the liquid surface and bottle cap found by FIG. 8C.

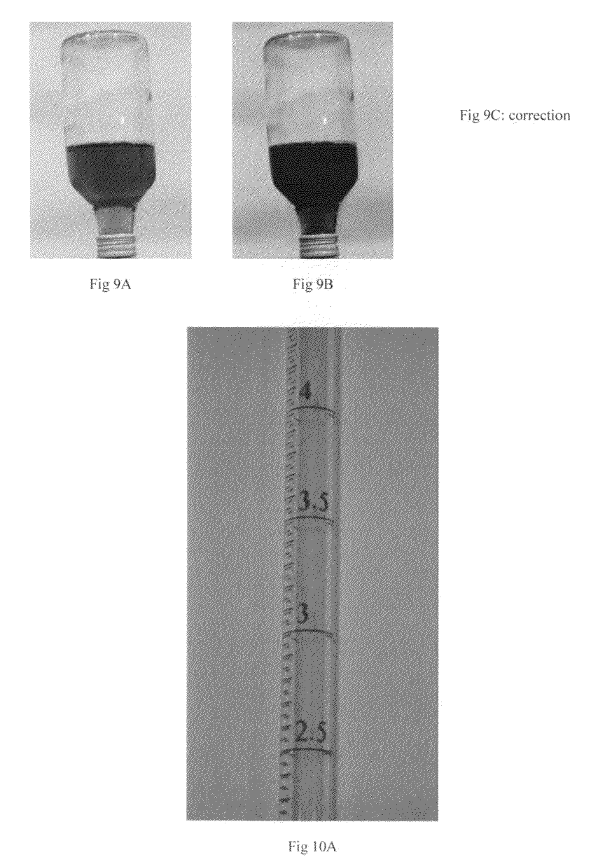

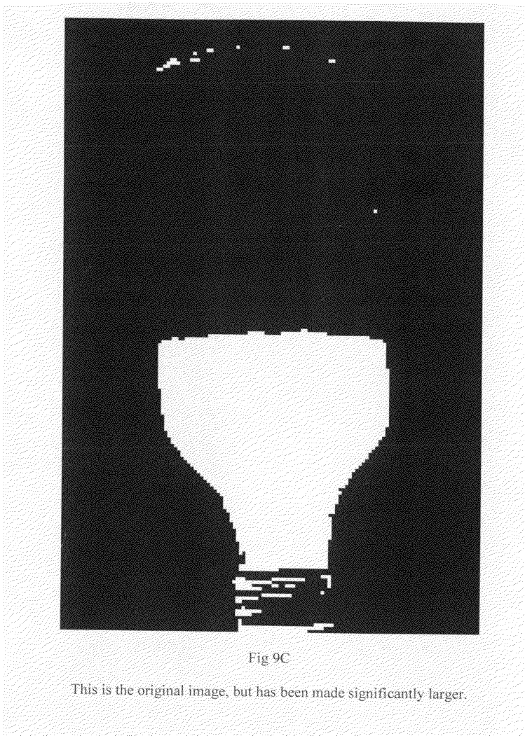

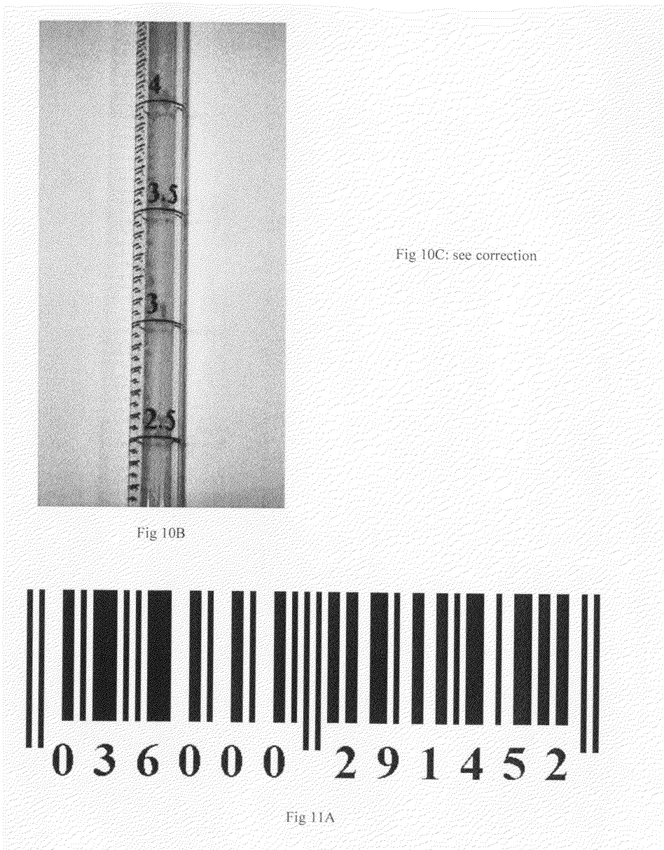

FIG. 9A to 9C shows the process of finding the liquid body in the container when the liquid is of a distinct color.
1. FIG. 9A shows the image of a bottle containing brownish liquid.
2. FIG. 9B shows the “distance image” from the average color of the liquid.
3. FIG. 9C is the result of thresholding on FIG. 9B using Otsu's method.

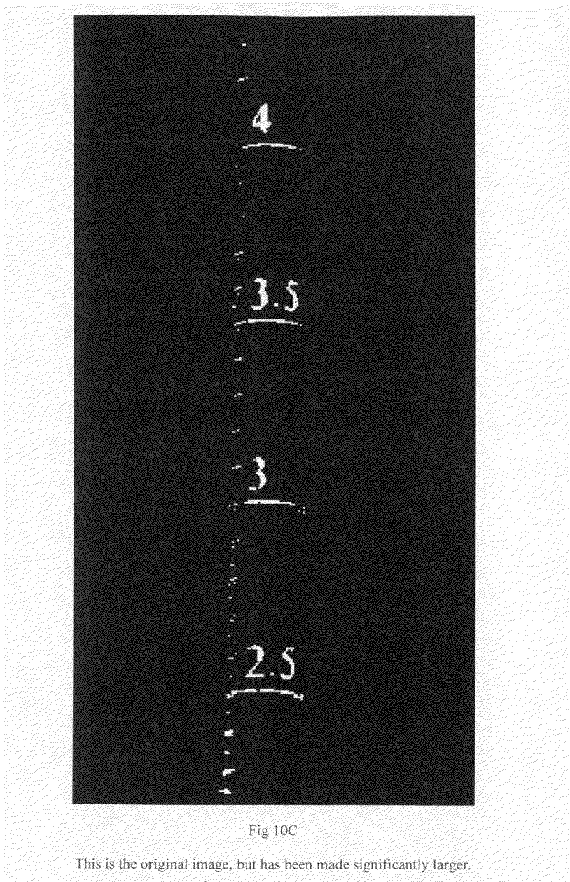

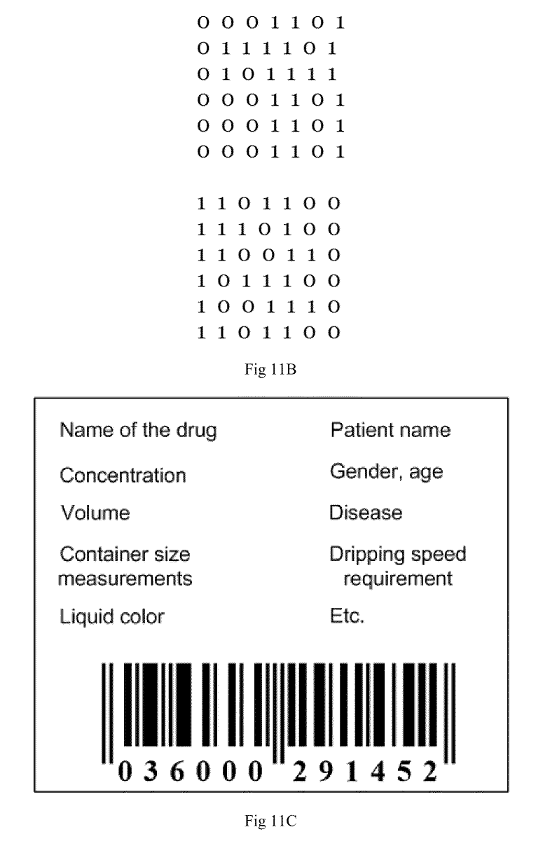

FIG. 10A to 10C shows how to extract ticks and measurements on surface of the container.
1. FIG. 10A is the image of a dropper with ticks and numbers denoting measurements on its surface.
2. FIG. 10B shows the “distance image” from the average color of the numbers.
3. FIG. 10C shows the result o thresholding FIG. 10B using a gray level that is 10% of the highest gray level in a gray scale image.

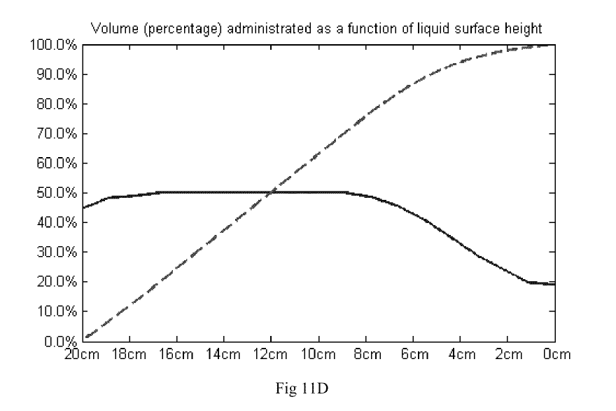

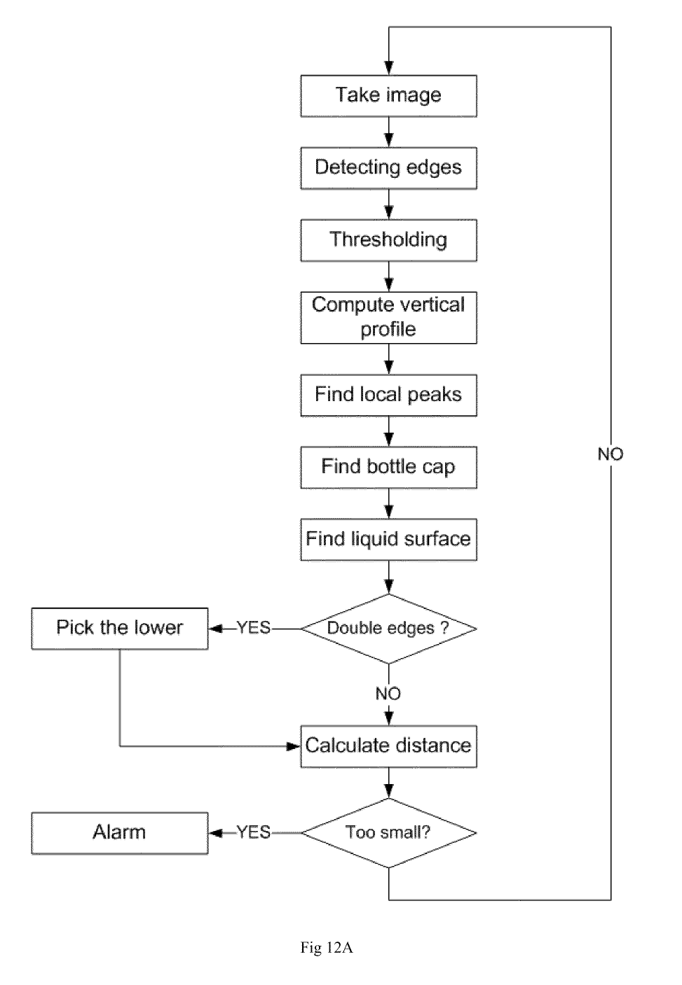

FIG. 11A to 11D shows how barcode can be used to provide information to the monitor.
1. FIG. 11A shows an example of a typical barcode.
2. FIG. 11B shows the scanning result of FIG. 11A.
3. FIG. 11C shows a label containing barcode.
4. FIG. 11D shows the diameter profile of a container and a function of the volume of liquid (in percentage) that has been administrated with respect to the remaining liquid height.

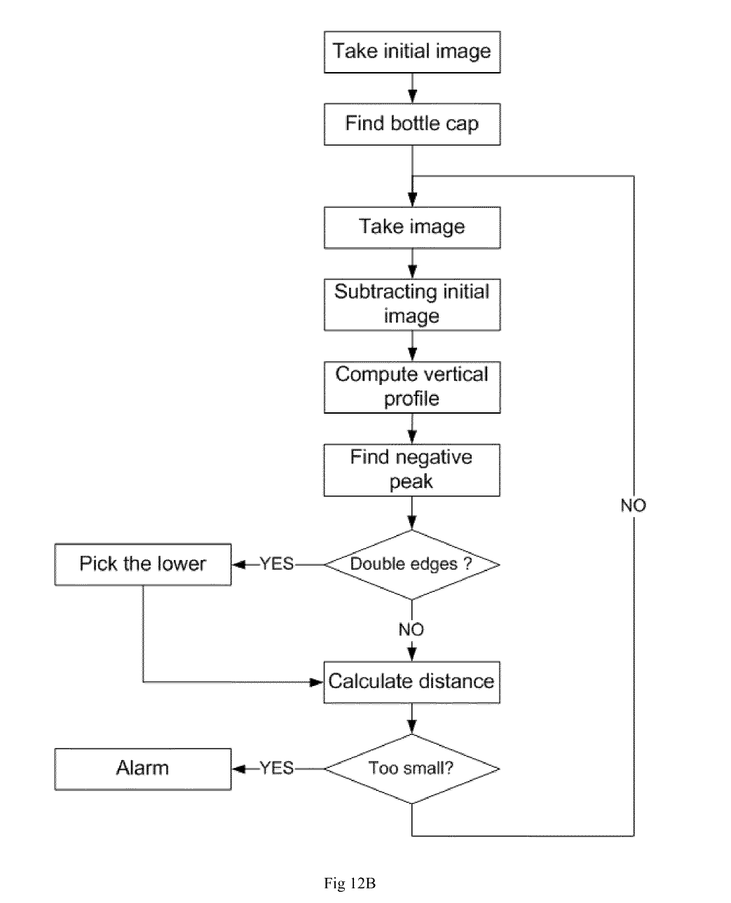

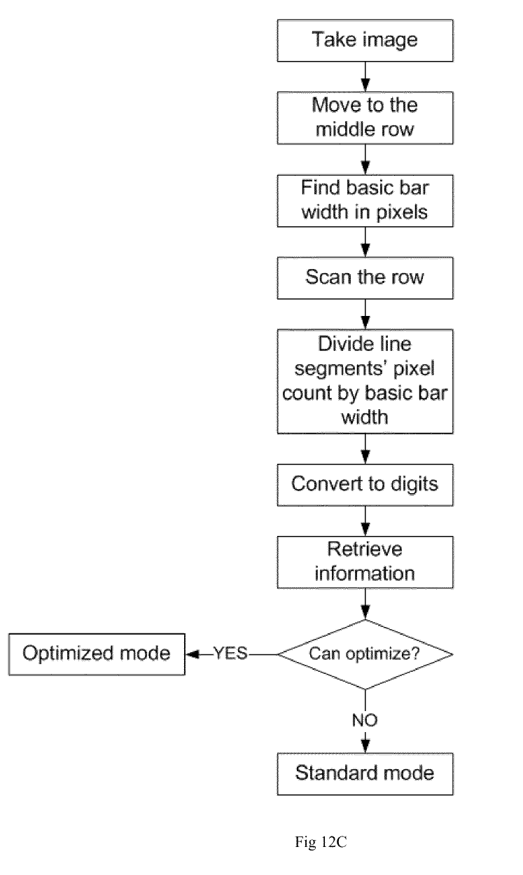

FIG. 12A to 12C shows flowchart description of some embodiments.
1. FIG. 12A shows an embodiment of the monitoring process based on edge detection methods.
2. FIG. 12B shows an embodiment of the monitoring process based on computing the difference between images taking at different times.
3. FIG. 12C shows an embodiment of the process of using barcode information.

### REFERENCE NUMERALS

11 Containing box
12 IV container
13 Label with barcode
14 Camera fixed on the door of the box
15 Independent processing unit
16 Light source
17 Remote monitoring computer

### DETAILED DESCRIPTION

### FIG. 1—One Possible Embodiment of the Hardware

11 is a containing box which is made of non-transparent material so that no outside light could come in, ensuring an ideal, constant shooting environment for the camera.

12 is the IV container which has its standing fixed by some transparent fixtures, which are not shown in the drawing.

13 is a label containing information about the drug, the container as well as other things. The lower half of the label contains a barcode which will be explained in the description of FIG. 11.

14 is a camera which is fixed on the door of the box. It will face the bottom of IV container when the door closes.

15 is a independent processing unit which is capable of process the captured image by itself alone.

16 is the light source inside the box serving the same purpose as 11.

17 is a remote monitoring center which can perform the task of 15 for a large number of monitoring cameras.

### FIG. 2—Concepts and Tools for Digital Image Processing

Our ultimate goal is to let the computer detect the location of liquid surface, calculating its distance from the bottom and alert us when they become close, much the same as we did with naked eyes. But how should that be achieved with a camera and a computer?

What we are actually doing is to simulate the visual process. In most cases we found the liquid surface not by its color since drugs being administrated are usually colorless. For a colorless and transparent liquid, its most salient feature appealing to the human eye is the relative darkness of the liquid surface, which is an optical phenomenon. We see this edge readily and decides that this is the location of the liquid surface and then looks to see if this level is already close to the bottom or not.

We use derivatives to enable computer to find the same edge as human does. The left of FIG. 2A shows part of an image which has a gradual transition from black to gray in the middle part. In computer's inner representation, gray scale images are represented by values within the range [0,255], which transits from 0 for black to 255 for white. The top of the right part of FIG. 2A shows the horizontal profile of the left part in which we see a ramp. To illustrate the nature of the concepts we do not distinguish strictly between discrete and continuous here.

The first derivative in horizontal direction at (x,y) is defined as

I(x+1,y)−I(x,y)

In which ‘I’ stands for the gray scale value.

The middle of the right part shows the first derivative of the horizontal profile on the top. We notice that:
1. In areas of constant gray level the first derivative is zero.
2. The first derivative is positive for transition from a darker to brighter area, and negative for transition from brighter to negative area.

Since edges corresponds to gray level transition, by property 2 edges have nonnegative first derivative, either positive or negative. By property 1 areas of constant gray level has zero first derivative. We therefore can focus only areas whose first derivative has absolute value large enough, which is the principal tool we will use in IV monitoring.

The second derivative is defined as the first derivative of the first derivative, by this definition it is:

$$\begin{matrix}FIRST ( x , y ) - FIRST ( x - 1 , y ) = [ I ( x + 1 , y ) \text{-} I ( x , y ) ] - \\ [ I ( x , y ) - I ( x - 1 , y ) ] \\ = I ( x + 1 , y ) - 2 I ( x , y ) + I ( x - 1 , y )\end{matrix}$$

The bottom of the right part of FIG. 2A shows the second derivative. We notice the difference between it and the first derivative:
1. Within the transition the second derivative is zero.
2. There are positive and negative values at two ends of the transition.

These two differences suggest consequently different utility and treatments when using these two kinds of derivatives.

One important point to notice here is the introduction of negative values by derivatives (both kinds). Since gray scale images are represented within the range [0,255], rescaling is needed after the operation. There are different implementations for the scaling, but typically all will map zero values after the taking the derivative to mid-ranged values in the gray scale. We will see this effect in FIG. 3.

FIGS. 2B and 2C are two slightly different implementation of the first derivative operation, called Sobel gradient and Prewitt gradient respectively. FIG. 2D is a vertical Laplacian operator, one of the implementations for the second derivative. In the realm of digital image processing, they are called masks, filters or operators interchangeably. Convoluting these masks with the original image is called operation in the spatial domain, and in FIG. 7 we will show how similar effects can be achieved by using frequency domain methods.

Please refer to section 10.13 and 3.7 of [Digital Image Processing, 2ed, Prentice Hall, 2002, Gonzalez, Woods] for details of the first and second derivative and their various implementations, chapter 3 for gray level scaling.

We are concerning only the vertical movement of the liquid surface and hence only derivatives in the vertical direction, though embodiments can also use the “full” derivative measuring gray level change including in other directions. In below we do not differentiate between the term ‘derivative's and ‘gradient's/Laplacian and in places there will be used interchangeable.

### FIG. 3—Edge Detection by Using Operators in FIG. 2

With the preparation in FIG. 2 we are now all set to find edges in the images captured by the camera. FIG. 3A shows the “original” image on which following processes will be carried on.

FIG. 3B shows its result after applying the Sobel gradient operator. As we have discussed in the end of the description for FIG. 2, the result has been rescaled due to the negative values introduced by the first derivative. We also notice that the strongest response are at (from top to bottom)
1) The top of the image, which is actually the bottom of the bottle itself.
2) Liquid surface.
3) Light reflections at the neck of the image, which are they themselves the brightest part in FIG. 3A.
4) The cap of the bottle (at the bottom of the image).

We will show how to deal with these bright spots of reflections in the discussion of FIG. 5.

One question is how to deal with values of different signs. Since edges are darker than both the air above it and the liquid below it, in the transition between air-edge-liquid the gray level first falls and the raises, therefore under Sobel gradient it produces first negative values and then positive values, which is why we see the sharp contrast at two sides of the edge FIG. 3B. The same phenomena also appear at other edges.

One way handle is to consider only the nonnegative—or non-positive—values. Negative and positive values of a same edge only has spatial difference of several pixels therefore we can safely ignore this difference by taking either one of the two, since even when humans are monitoring the IV dripping with their eyes there are errors within a small range.

FIG. 3C shows the result of taking only the nonnegative values of the Sobel gradient operation on FIG. 3A. Since all values are nonnegative, scaling are no longer needed and zero values indeed appear as dark regions. All negatives values have been replaced by zero and are absorbed into the background, leaving only the positive values which are bright in the image.

FIGS. 3D and 3E differs from 3B and 3C only in the different gradient operator (Prewitt) used. By comparing FIGS. 2B and 2C it is clear that Sobel operator generally produces stronger result than Prewitt operator, which explains the sharper contrast in FIGS. 3B and 3C than in FIGS. 3D and 3E.

FIG. 3F is the result after applying vertical Laplacian operator in FIG. 2D to FIG. 3A. Like Sobel and Prewitt operator, there are negative values introduced and hence the overall gray level has been raised after rescaling. FIG. 3G is obtained in the way as done for the Sobel and Prewitt gradient operation by preserving only the nonnegative values of the result and convert all negative values to zero.

It is obvious by comparison that Laplacian results are much “finer” than Sobel and Prewitt gradient results. This is because, as we have explained for the bottom image in the right of FIG. 2A, Laplacian operator produce 1) zeros values within the ramp (linear gray level transition) 2) values of different signs at the entry and exit of the transition. The air-edge-liquid transition in the image consists of a fall followed by a rise in gray level, which can roughly be modeled by two consecutive ramps making up a “valley”. The difference in the mechanism makes Laplacian resulting image weaker (due to zero values within the ramp), yet finer than its gradient counterparts.

To summarize, FIG. 3B-3G show the result of applying Sobel, Prewitt and Laplacian operator to the captured image of a liquid-containing bottle. The purpose of these operators is to emphasize edges in the image while suppressing areas of constant or slow gray level change. It should be noted that the methods given here are only examples of the many possible ways of highlighting sharp edge transitions in the image, and the actual embodiment can pick any of the possible implementations, including but not limited to
1. Spatial domain methods such as gradient and Laplacian operators, or other types of masks, thresholding, local or global manipulation whose purpose is to highlight edge transitions in the image.
2. Frequency domain methods such as preserving high-frequency component in the image's 2D Fourier transform, which corresponds to sharper transitions in the gray level. Please refer to chapter 4 of [Digital Image Processing, 2ed, Prentice Hall, 2002, Gonzalez, Woods] for techniques in the frequency domain.

### FIG. 4—Edge Detection by Direct Thresholding

With the preparations in FIG. 3 we have already get closer to the final goal. Before proceeding to the next step which will be described in FIG. 5, let us discuss an alternative operation which in many situations yields edge detection results comparable to methods in FIG. 3.

The overall appearance of the original image (FIG. 3A) is that prominent dark areas exist only at the top part of the image (bottom of the glass bottle), the liquid surface as well as the concave grooves at the bottom of the image (cap of the glass bottle). This arrangement suggests that the detection of these areas can be done possibly by thresholding alone. We show examples below.

FIG. 4A is the result of applying direct thresholding to FIG. 3A by setting to white only pixels with gray level lower than 130. The result is desirable and can be used as an alternative of the methods used in FIG. 3.

However, this desirable result was achieved by carefully selecting the threshold level by the user. The threshold level used to achieve FIG. 4A is 130. Since our chief purpose is the automatic monitoring of IV process it is hoped that the threshold value can also be determined automatically. Otsu's method is a popular algorithm for automatically selecting threshold level and FIG. 4B shows its result. The result is not as good as FIG. 4A, containing wider edges, horizontal lines as well as unnecessary areas at the bottom of the image. The long horizontal white area at the bottom corresponds to part of the table in FIG. 3A on which the glass bottle is placed on. The color of the table after being converted to gray level (FIG. 3A is gray level) contains shades of gray and are relative darker, which were “detected” by Otsu's method.

FIG. 4C shows an image captured on the same glass bottle as in FIG. 3A but before a different background. FIG. 4D is the result of thresholding using manually selected threshold level 130, which is the same as used in FIG. 4A.

Comparing FIG. 4D and FIG. 4A, we find that even the bottles (foreground) and the threshold levels are exactly the same and that the result in the area of the bottle are close, there are unnecessary large areas at the top left and left bottom corners of the image, which is because of the different material and illuminational reflection of the background before which the image was taken.

FIGS. 4B and 4D highlights some of the difficulties on applying the intuitively correct method of direct thresholding. To summarize, the difficulties are:
1. Automatically selection of the threshold level.
2. Unnecessary areas that are not of interest.

Despite these difficulties, there can be, however, many different approaches to remedy these undesirable effects of direct thresholding. We describe non-exhaustively some of the methods:
1. Control the background and illumination, which can be easily done especially when the IV container is contained in a box like in FIG. 1.
2. Extracting the area of the image occupied by the IV container and only applying thresholding to that area.
3. Use prior knowledge of the material of the IV container, the color of its cap, etc.
4. Divide the whole image to subimages and use adaptive thresholding. Please refer to

Example 10.12 of [Digital Image Processing, 2ed, Prentice Hall, 2002, Gonzalez, Woods] for this method.

Thresholding is one of the most widely applied techniques in digital image processing and it has numerous variations and improvements to suit the situation. Therefore, the purpose of the examples given in FIG. 4 is certainly not to rule out the possibility of using thresholding based techniques in detecting edges, but is to highlight the advantages as well as to impress upon the reader caveats that should be aware of.

We also state that in environments (background, illumination, etc.) that are well controlled, thresholding alone can be used as an alternative to other edge detecting methods and we admit direct thresholding as one of one of our embodiments for the step of edge detection.

### FIG. 5—Detection Based on the Vertical Profile

As we have discussed in FIGS. 3 and 4, various approaches can be used to detect edges in the image. In the examples below we base our following processing on the result of taking the nonnegative values of the Sobel gradient operation (FIG. 3C). Any preprocessing method that highlights the edges well could serve our purpose and the use of Sobel gradient here should only be regarded as an illustration rather than limitation.

FIG. 5A shows the image histogram of the nonnegative part of the Sobel gradient result (FIG. 3C). In consistency with FIG. 3C itself we see that most of the pixels have gray level lower than 50. These are the weak responses to the Sobel gradient operator and correspond to areas of constant or slow-changing gray scale value.

We again use Otsu's method for automatically finding the threshold level in the image. For details of this algorithm please refer to [Otsu, Nobuyuki., “A Threshold Selection Method from Gray-Level Histograms,” IEEE Transactions on Systems, Man, and Cybernetics, Vol. 9, No. 1, 1979, pp. 62-66.]. We also state that the choice of Otsu's method should not be interpreted as a limitation and any automatic algorithms resulting in a desirable thresholding result would work for our purpose.

The threshold level found by Otsu's method for the Sobel gradient result (FIG. 3C) is 88 and FIG. 5B shows the thresholding result making white pixels have gray level intensity larger than 88 and black for those with values below this. The nature of this step is that we have hereby transformed the gray level response of the Sobel gradient to a binary image which is more amenable for further computation. It is obvious that the result is desirable and the locations of the liquid surface and the cap and bottom of the glass bottle (on top of the image) are all visually clear. Spots at the neck of the bottle due to reflection also remain in the result, but they are scattered apart rather than forming horizontal line segments and can be easily differentiated from the lines that we are aiming to find.

Up to now, the process can be summarized as gray level->gray level->binary conversion. The gradient operation performs the first stage of the conversion to highlight edges and suppress non-edge areas, and the second stage of the conversion selects the strong edge detection responses and ignores other areas. The two stages of simplification has brought the essential feature to the foreground and greatly reduced the complexity of the task. We follow this spirit further to convert the 2D binary image to a 1D vertical profile and use that as the basis of our decision.

We obtain the vertical profile by scanning from top to bottom each row in the image and counts for each row the maximum number of consecutive white pixels. The reason that we are counting only consecutive white pixels is to differentiate between proper line segments and broken spots which are mostly caused by light reflection. Since only the maximum count of consecutive points was recorded, a row with many reflection spots scattered on would only have the count of the widest spot, which will be much smaller than the count for any appreciable line segments.

The scanning result for FIG. 5B is shown in FIG. 5C. The height of FIG. 5B in terms of pixels is 216 and this is accordingly the length of the horizontal axis of FIG. 5C. It is visually clear that there are four clusters in this vertical profile which from left to right (top of the image to the bottom) correspond to
1. bottom of the glass bottle
2. liquid surface
3. reflections at the neck
4. cap of the glass bottle

It is also consistent with the discussion in the previous paragraph that the reflection spots, despite their possible plurality in several rows, have been counted only to the maximum consecutive points in each row and are consequently have much smaller number peaks than in the other clusters.

From the transition from the original acquired image (FIG. 3A) to FIG. 5C, the task of finding prominent edges in the 2D, gray scale image has been transformed to finding peaks in a 1D function, a great simplification which we have achieved.

FIG. 5D displays the peaks within FIG. 5C. The precise definition of “peak” in a 1D function is not a trivial issue technically. In this embodiment we define a peak to be a value satisfies the following two criteria:
1. Its value is the largest in the neighborhood centered at itself with length 7, i.e., count(x)=max(count(x−3), . . . , count(x), . . . , count(x+3)).
2. It value is larger than 20.

The purpose of criterion 1 is to detecting the local maxima. Criterion 2 serves to eliminate those local peaks within the area corresponding to reflection spots. As we have explained, these scatter spots doesn't make significant consecutive length and are discarded accordingly.

There is enough simplicity in FIG. 5D that the decision can be made instantly. No image analysis is done without the knowledge of context and this widely accepted maxim justifies our incorporation of the prior knowledge of the image. What is the so called “prior knowledge”? This computerese refers to anything we know about the task at hand. For example: the color of the background, the height of the bottle, the distance between the camera and the bottle, etc. There is also a balance need to be struck between the “automatic” decision-making ability of the algorithm and the prior knowledge being fed into the program, since the more input the computer requires the less convenient it becomes.

We use only one prior knowledge in this embodiment: the height of the bottle cap. For most IV containers the height of the cap is between 2 cm and 3 cm (0.8 to 1.2 inch), and this in our image corresponds to no more than 25 pixels. The size of the captured image (FIG. 3A) is 165 pixels in width and 216 pixels in height, and since FIG. 5D is its vertical profile, the height of the cap being smaller than 25 pixels means that we can simply divide the profile to two parts: from 192 to 216 for the cap and the remainder for the other.

It is perfectly fine, given the simplicity of the captured image, to not use any of these prior knowledge in the algorithm. A more sophisticated embodiment could automatically recognize the shape of the container, perform segmentation and divide it into proper parts, normalize the size of the image if the distance between the IV container and the camera has been changed, as well as implementing other functionalities. Even if these sophisticated algorithms are not employed, improvements that lead to a more “intelligent” peak detection algorithms could adapt most types of IV containers without any prior knowledge. However, none of these improvements and variations changes the essence of the algorithm. Also because in real medical practice the distance between the camera and container, as well as other parameters, can be controlled at the time of manufacturing or by nurses, the use of the knowledge of the height of the container cap can be convincingly justified.

In the cap region [192,216] we scan leftwards from the right end for local peaks and find the fourth peak's location to be 195, and mark it by a red line in the original image as shown in FIG. 5E. We then scan leftwards within [1,191] from 192 and identifies the first peak as the location of the liquid surface, which is row 102 in FIG. 3A. This is marked by a yellow line in FIG. 5E. We present FIG. 5E as a vivid demonstration of the result of our program (one embodiment) and shows that the liquid and cap location can be accurately detected using digital image processing technique.

The automatic monitoring works by taking continuously or at regular time intervals image of IV container and performs the analysis such as by the current illustrational embodiment, and calculates the distance between the liquid surface and the cap of the container. When this distance becomes smaller than a certain value it alarms the patient, his/her companion or the nurse. It can also cut off the dripping by commanding a connected mechanical device to perform this if the distance has become critically small.

Hough transform is a widely used algorithm in image analysis for line detection and the reader could refer to section 10.22 of [Digital Image Processing, 2ed, Prentice Hall, 2002, Gonzalez, Woods] for its detail. It consists of first detecting the edges at all directions and then count in each direction consecutive points that make significant line segments. The use of Hough transform for detecting the liquid surface and the cap location is shown in FIG. 5F and the result is very close to FIG. 5E. Note that in FIG. 5F not only horizontal lines but also line segments of a small angle from the horizontal direction have been detected, which is the unique feature of the Hough transform. Since in the image of a liquid containing bottle is vertically placed most of the visually perceivably “lines” are horizontal, the Hough transform reduces largely to horizontal line detection in this application.

We provide this example to show that as an alternative embodiment, line detection algorithms based on Hough transform can also be used to detect the liquid surface and the location of the container cap, and would work for the purpose of IV monitoring.

### FIG. 6—The Difference Between Image Taken at Different Times

One that is long steeped in the field of digital image processing should be familiar with techniques that are used for vehicle motion detection. Since the background is largely static, the change in the image content is introduced by the movement of the object and can be analyzed by computing the difference between images captured at different times.

Similar technique can also be applied on the monitoring of IV process. Since the background and the bottle itself are static, the only change in the image content is due to the descending of the liquid surface and can be easily extracted. FIG. 6A contains three images. On the left is a copy of FIG. 3A putting here for convenience of comparison. The middle is the captured image of the same bottle containing the same kind of liquid but with lower surface. The right image shows the difference of subtracting from the middle image the left one and the result has been rescaled for the negative values introduced.

The effect of subtraction removes most of the contents in the image such that the different shades of gray in the background have been completely eliminated. Ideally, the bottle itself should also be removed if its standing has been kept static, but we could still see the vague shape of it by looking carefully. This is due to:
1. Slight change in its standing and as well as change in the position of the camera.
2. The change in light reflection due to the change of liquid height.

This remaining faint shape of bottle is, however, nevertheless much weaker. The prominent features in the image now the two strong horizontal lines: the upper brighter one and the lower darker one, which are results of the subtraction of the two edges (liquid surfaces).

This image alone is enough for the purpose of surface detection. We like before also obtain a vertical profile from it by in each row calculate the difference between the maximum consecutive positive points and the maximum consecutive negative points, and the result is shown in FIG. 6B. It would be very easy to detect the largest negative peak in the profile which corresponds to the current liquid surface.

It is now evident from the above discussion the difference image is also a desirable method for detecting the liquid surface. The cap of the container can be detected by using other methods such as those used in FIG. 5 and it needs to be calculated only once.

We therefore assert that the use of difference image is also an embodiment for IV monitoring.

### FIG. 7—Edge Detection Using Frequency Domain Methods

The task of edge detection can also be done in the frequency domain. FIG. 7A shows the frequency domain plot of the vertical Sobel gradient operator as in FIG. 2B. It is multiplied with the discrete Fourier transform (FIG. 7B) of the original captured image (FIG. 3A) to produce the filtered Fourier representation (FIG. 7C), this filtered representation will then go through the inverse transform to yield the filtered image (FIG. 7D). Edges in FIG. 7D are emphasized as comparing with FIG. 3A, and further processing as in FIG. 5 can be performed on this image.

We present the result in FIG. 7 to show that Edge detection using frequency methods is also a possible embodiment. Edges in the image correspond to high-frequency components of its transform, therefore a large array of high-pass filters can be used for this purpose.

### FIG. 8—Double Edges of Liquid Surface

In all of our previous examples, the liquid surface corresponds to one of the prominent local peaks. But what happens when you are viewing the liquid surface from a much higher or lower position such that there is a significant angle between the horizontal line and the line connecting your eye and the liquid surface?

This is in fact not allowed if you are reading the volume of liquid in a beaker, and the right way is to move your eye so that it is at the same horizontal line with the lowest point of the liquid's concave surface. We of course can stick to this standard by tracking the height of the liquid surface and moves the camera vertically with some mechanical device, such as a micro-motor, but this introduces further complication and expenses.

FIG. 8A shows an image of the same bottle as in FIG. 3A and the liquid height is relatively low. There is a ring-like structure comprising of one edge in the front of the bottle and one at the back. This “double-edge” phenomenon is result of both the relative location of the camera and the optical reflection/refraction, which is not a subject of our interest. After the edge detection using Sobel gradient and thresholding by Otsu's method, the binary image is shown in FIG. 8B, and the vertical profile has been subsequently calculated and has local peaks detected, as shown in FIG. 8C. Clearly, there are two edge candidates to be identified as the liquid surface.

There are several approaches to deal with this problem. For example, one can use the knowledge of the relative location of the camera to the container. If the camera is placed at the height same as the cap of the bottle, usually the upper edge is the liquid surface meeting the front side of the bottle's inner surface. For other positions of the camera, judgments can be similarly made, and these are all possible embodiments.

Another embodiment is to simply “err on the safer side”: we pick the lower of the two edges and compare this with the location of the cap. This is not in all cases the right decision but is nevertheless can be justified to some extent, since safety is one of the most important considerations in medical devices.

FIG. 8D marks the lower edge and the bottle cap and the distance can be calculated accordingly.

The solution presented here is just one embodiment and we admit other types of technique to detect the liquid surface when this situation arises.

FIG. 9—Liquid with Color

IV solution with color is rare in medical practice and in these cases different algorithm can be used. FIG. 9A shows an image of a bottle containing a brownish liquid, and the average RGB (red, green, blue) value of the liquid area is (131, 79, 35). FIG. 9B is the a “distance image” whose pixel values corresponds to the Euclidean distance in the RGB space between the each pixel's RGB triple and the average RGB value of the liquid. FIG. 9C thresholded FIG. 9B using Otsu's method. It is clear that some simple processing could extract the location of the liquid surface from the result.

The average color of the liquid can either be instructed by the human, or automatically detected such as first finding the location of the liquid in the image and then compute the average color. Whether or not the image has color can also be determined automatically.

Therefore, an additional embodiment for liquid surface detection could first
1. Identify whether or not the liquid has color
2. Calculate the average RGB value of the liquid from some sample points
3. Obtain the “distance image”
4. Perform automatic thresholding or segmentation on that image

There can of course be many other implements to the situation end and the scope of our invention should not be limited to any particular embodiment.

### FIG. 10—Reading Numbers on the Container

We might need to measure or control the speed of the dripping process. Rather than optional, this is in fact a requirement in the medical practice, especially for patients of weak cardiovascular conditions. Existing devices typically do this by using an optical sensor to count the number of drips. Due to variations in such as the pressure and density of the solution, the volume of each drop differs between different types of drugs and could also changes over time during the dripping process for the same type of drug. These variations lead to problems and complications for the optical sensor counting methods if they want to compute the volume that has been administrated from the drop counts.

Since detection of the liquid surface location is now possible, if there are also numbers marking the volume on the outside of the container, we could compare the surface location with these number to calculate the volume of the remaining liquid, volume that has already been administrated and the speed of the dripping. All these must be done by first recognizing the numbers on the container.

FIG. 10A shows a dropper with marking number and ticks on it. The average RGB color of the marking is (97, 73, 52) and we obtain in same way the “distance image” as in FIG. 9B. A thresholding based on 10% of FIG. 10B's highest value yields FIG. 10C in which the numbers and ticks have been extracted. The quality of this result makes it amenable for accurate automatic character recognition which is nowadays already a mature and reliable technology.

The extracting of numbers and ticks can also be done in many other ways, allowing different embodiments for the same purpose.

The example here is based on FIG. 10A, which is the captured image of a dropper of a very small diameter, making numbers and ticks bend on its surface. In addition to that there are also heavy shadows in the image. For real IV containers that are much wider than this, numbers will appear largely flat and there will also be much less shading effect, making the extraction easier than in the present example.

### FIG. 11—Using Barcode

We have mentioned the need for the program to know some “prior knowledge” of the IV container and the liquid, for example:
1. In FIG. 5 the detection of bottle cap location, to know the height of the cap.
2. In FIG. 8 double edges, to know the relative positioning of the bottle with respect to the camera.
3. In FIG. 9 the color of the liquid.
4. In FIG. 10 the color of the marking numbers and ticks on the container.

Once such information is known, the program can be optimized to work under the corresponding model. For example, if the height of the cap is known, the program can process only part of the image above the cap and detect the liquid surface in that area; if the color of the liquid is known, the program can perform segmentation in the RGB color space and immediately separate the body of the liquid from other contents in the image.

It would be both inconvenient and error-prone is all these information has to be entered into the program by the operator. We describe here a method of supplying these information with barcode to the program.

FIG. 11A shows the example of a Barcode implementation which is called Universal Product Code (UPC). Black bar represent 1 and White bar represent 0. At the left, middle and right there are the longer bars representing distinct bit patterns of 101, 01010 and 101 respectively, and the program can detect the width of a single (basic) bar from the rightmost or the leftmost. All those bars that appear wider are concatenation of basic bars.

The image of the barcode can be captured, and the program will scan rightwards to find the first consecutive black width, using it width in pixels as the basis for further computation. It will then keep on scanning rightwards, measuring the length of each black and white width in terms of the basic width (dividing that), discarding the left, middle and right bit patterns (see above paragraph. Please refer to UPC standard for more on its detail.) Every decimal digit is represented by seven bits and there are six decimal digits both before the middle bits pattern and after that. The program will convert a black basic width to 1 and a white basic width to 0, generating the bit pattern for each decimal digit as shown in FIG. 11B.

The bit pattern in FIG. 11B will then be decoded to the digits it represents under the corresponding barcode scheme. Of course, we give the above example in UPC scheme to illustrate the concept, and we can design dedicated coding scheme solely for IV container barcodes.

These digits can be used to represent arbitrary information:
1. There can be a standard for IV container barcode within a certain domain (a hospital, a nation, or globally) such that different bit of digits represent different information, in much the same way as a computer file. For example, the first five digits represent the drug type, the next three represent the container type, the next two for liquid color, etc. Especially in the case when a global standard has been established, this standard can be stored in the internal memory of the hardware and the monitoring device can work independently without querying the information from a central server.
2. One can also use non-standard code, such as designed by a hospital internally. In this case, it is more convenient for the monitoring device to send the code to a central server and receive the decoded result from that.

In either cases the program will switch to the optimized mode if specific information such as liquid color is available, or otherwise work in the general mode.

A label design is shown in FIG. 11C. The top part contains eye-readable printed or even written characters containing information as shown in the picture. The barcode lies at the bottom and can be captured and read by the program. These information can also be remotely displayed at the nurse station for their better information.

The label can be printed on a sticker like surface and attached to the container by the manufacturer or the hospital. When the drug is being administrated the label will be took off from the container and put onto the back wall of the box in FIG. 1. A fixed area could be designated for putting the label in the box of FIG. 1, hence the program will not need to find the position of the label in the acquired image.

We have mentioned in FIG. 10 speed control for patients such as of weak cardiovascular condition is important, and in the embodiment of FIG. 10 the speed is measured by first comparing the surface level to the marking ticks and numbers for which character recognition is required. The use of barcode allows a simpler solution. The monotonically increasing curve in FIG. 11D depicts the function of volume (in percentage) of liquid that have been administrated with respect to surface height, and another curve is the vertical profile of the diameter of the container. Since the height and other precise measurements of the container can be retrieved by the barcode (these can be provided by the manufacturer of the container), we can compute the surface area-height function and derive FIG. 11D by integration. In fact, this can be provided also by the container's manufacturer.

We use barcode to provide many of the helpful knowledge to the monitoring program and it greatly simplifies much of the task. There can also be 2D barcode as well as other coding schemes, which can all be processed with the captured image. Therefore use of specific examples in FIG. 11 should be understood as an illustration rather than any limitation.

### FIG. 12—Flow Charts

FIG. 12A shows an embodiment of the monitoring process based on edge detection methods.

FIG. 12B shows an embodiment of the monitoring process based on computing the difference between images taking at different times.

FIG. 12C shows an embodiment of the process of using barcode information.

We make here both statement and acknowledgement that as a choice of programming environment for the illustration, we used MATLAB® 7.6.0.324 (R2008a) of The Mathworks, Inc. Embodiments of this invention in practice can use any suitable programming language to implement the logic.

What is claimed is:

1. An apparatus monitoring IV process using digital image processing techniques, comprising
a) an image capturing device, such as a camera, to capture image of the IV container;
b) a dedicated hardware or software, or their combination, whose function is to perform digital image analysis based on the acquired image from the said image capturing device.

2. An apparatus of claim 1 detecting
a) liquid surface, or
b) liquid surface and cap of the IV container by edge detection methods

3. An apparatus of claim 2 directly uses thresholding based technique as its edge detection method

4. An apparatus of claim 2 detecting edges using spatial domain methods, including but not limited to
a) First derivatives such as gradients, including their various implementations and approximations
b) Second derivatives such as Laplacian, including their various implementations and approximations

5. An apparatus of claim 2 detecting edges by computing the difference between images taken at a later time and a prior time.

6. An apparatus of claim 2 detecting edges by filtering the image in the frequency domain to detect edges.

7. An apparatus of claim 1 to be used for IV liquid of a distinct color, which detects the upper surface, or the upper surface and the bottom location of the liquid body, by identifying first the part of the image corresponding to the liquid body by using the closeness of the color, with methods including but not limited to
a) segmentation in the color space
b) segmentation using individual color planes of the image

8. An apparatus of claim 1 that reads the marking numbers and ticks of a distinct color on the IV container by first extracting them using color based methods, including but not limited to
a) segmentation in the color space
b) segmentation using individual color planes of the image

9. An apparatus of claim 8 that monitors the administrated volume of the drug by comparing the liquid surface location with the recognized numbers corresponding to the matching tick and computer accordingly.

10. An apparatus of claim 8 that monitors the instant and average speed of the dripping by first comparing the liquid surface location with the recognized numbers corresponding to the matching tick and compute accordingly.

11. A label, or any type of printed material, or information itched or printed on body or cap of the IV container, which contains
a) barcode, or
b) barcode and other printed or written information so that relevant information of the IV drug and container can be obtained by reading the barcode from the image in a way that is analogous to the optical scanning of barcodes.

12. An apparatus that reads the barcode of claim 11, obtaining from it the fine-grained measurements of the IV container, and uses this information to monitor the volume of drug that has been administrated as well as the instant and average speed of the dripping.
